(19) United States
(12) Patent Application Publication
(10) Pub. No.: US 2010/0017430 A1
(43) Pub. Date: Jan. 21, 2010

(54) SYSTEM AND METHOD FOR DOCUMENT PROCESSING JOB MANAGEMENT BASED ON USER LOGIN

(76) Inventor: Marianne L. Kodimer, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/176,467

(22) Filed: Jul. 21, 2008

(51) Int. Cl. G06F 7/00; G06F 17/30

(52) U.S. Cl. 707/102; 707/E17.008

(57) ABSTRACT

The subject application is directed to document processing job management. Login data is first received corresponding to an associated user. Electronic documents are then associatively stored with a user identifier in an associated data storage. A default menu is generated on a user interface associated with a document processing device, and an actively displayed default menu on the user interface is determined. Document set data is then generated corresponding to an association of electronic documents in the data storage and received login data based upon the correlation between the login data and the associated user identifier. Summary listing data is then generated that identifies each electronic document in the data storage based upon the generated document set data and upon the determination that a default menu is actively displayed on the user interface. Thereafter, a display is generated corresponding to the summary listing.

### BACKGROUND OF THE INVENTION

The subject application is directed generally to processing of one or more electronic documents queued in memory for processing by a document processing device. The application is particularly applicable to facilitating an unobtrusive mechanism by which a user can easily select and process previously submitted jobs.

Document processing devices include printers, copiers, facsimile machines, and scanners. More recently, devices have more than one of these functions, and are referred to as multifunction peripherals (MFPs) or multifunction devices (MFDs). Given the power and flexibility of modem document processing devices, they are used in connection with a variety of business related tasks.

Modern document processing devices can readily communicate instructions and data, including electronic documents, with a variety of devices and through a variety of data communication modes. Information is exchanged with conventional computers, such as laptop or notebook computers, as well as desktop computers including workstations. Information is also exchanged with various portable data devices. Such portable data devices include personal digital assistants (PDAs), smart phones, data storage devices, and the like. Data or instruction interchange is suitably completed via a network connection, or via point-to-point data links between devices. Network connections included wired networks, such as Ethernet or Token-Ring; or wireless connections such as WiFi (802.11x) or WiMax. Point-to-point data or instruction interchange is suitably accomplished via serial connection, universal serial bus (USB), Bluetooth, FireWire, modem, or any other suitable data connection.

With such a variety of device connections and data or instruction interchange modes, it is extremely easy for users to send one or more electronic documents to a device for processing. There are times when document processing of such files is deferred. Such situations include those in which a user is not yet physically at a device, when payment is not yet completed, or when deferred processing is otherwise desirable. In such instances, there may be a queue of document processing jobs associated with various users.

### SUMMARY OF THE INVENTION

In accordance with one embodiment of the subject application, there is provided a system and method for processing of one or more electronic documents queued in memory for processing by a document processing device.

Further, in accordance with one embodiment of the subject application, there is provided a system and method for facilitating an unobtrusive mechanism by which a user can easily select and process previously submitted jobs.

Still further, in accordance with one embodiment of the subject application there is provided a system and method for document job management. Login data corresponding to an identity of an associated user is received. A plurality of electronic documents associated with at least one user identifier is stored in an associated data storage. A default menu is generated on a user interface associated with a document processing device. A determination is made whether the default menu is actively displayed on the user interface. Document set data corresponding to an association of electronic documents in the data storage and received login data is generated in accordance with a correlation between received login data and the at least one user identifier. Summary listing data identifying each electronic document in the data storage in accordance with generated document set data and the determination that the default menu is actively displayed on the user interface and a display corresponding to the summary listing is generated.

Still other advantages, aspects and features of the subject application will become readily apparent to those skilled in the art from the following description wherein there is shown and described a preferred embodiment of the subject application, simply by way of illustration of one of the modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a document processing job management system according to one embodiment of the subject application;

FIG. 2 is a block diagram illustrating controller hardware for use in the document processing job management system according to one embodiment of the subject application;

FIG. 3 is a functional diagram illustrating the controller for use in the document processing job management system according to one embodiment of the subject application;

FIG. 4 is a diagram illustrating a workstation for use in the document processing job management system according to one embodiment of the subject application;

FIG. 5 is a diagram illustrating a server for use in the document processing job management system according to one embodiment of the subject application;

FIG. 6 is a flowchart illustrating a document processing job management method according to one embodiment of the subject application; and

FIG. 7 is a flowchart illustrating a document processing job management method according to one embodiment of the subject application.

### DETAILED DESCRIPTION OF THE PREFERRED EMBODIMENT

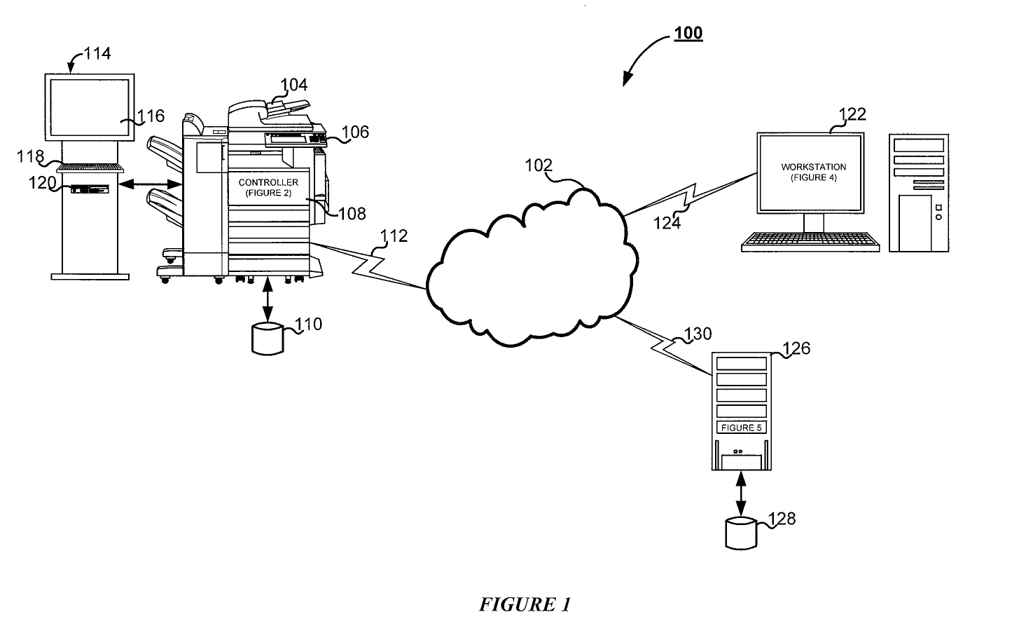

The subject application is directed to a system and method for the processing of one or more electronic documents queued in memory for processing by a document processing device. In particular, the subject application is directed to a system and method for facilitating an unobtrusive mechanism by which a user can easily select and process previously submitted jobs. More particularly, the subject application is directed to a document processing job management system and method. It will become apparent to those skilled in the art that the system and method described herein are suitably adapted to a plurality of varying electronic fields employing job management, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for document processing job management in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

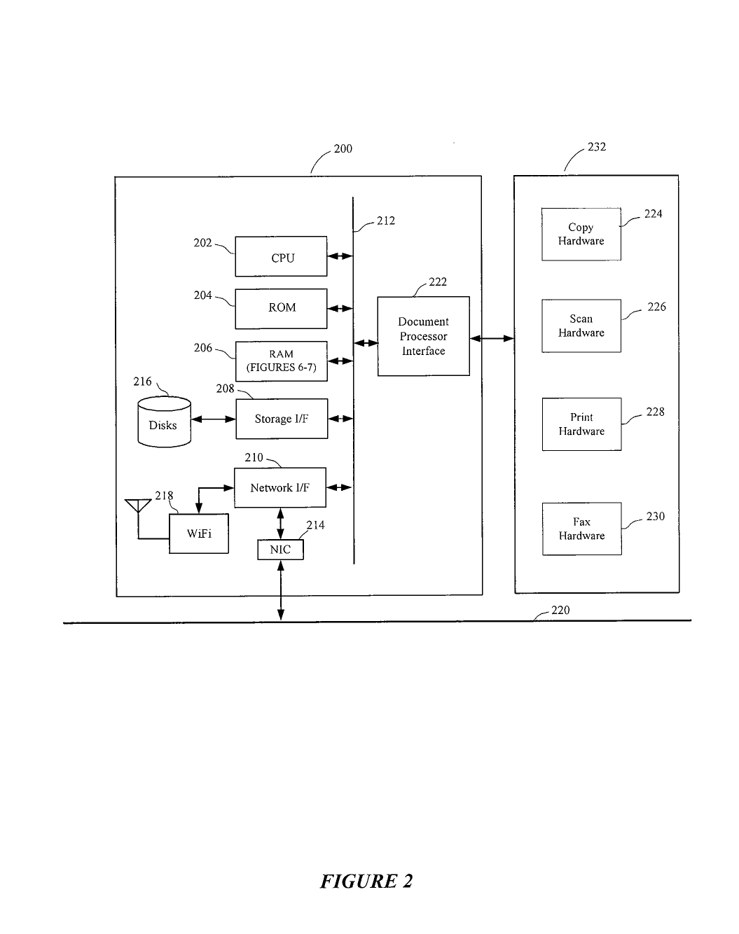

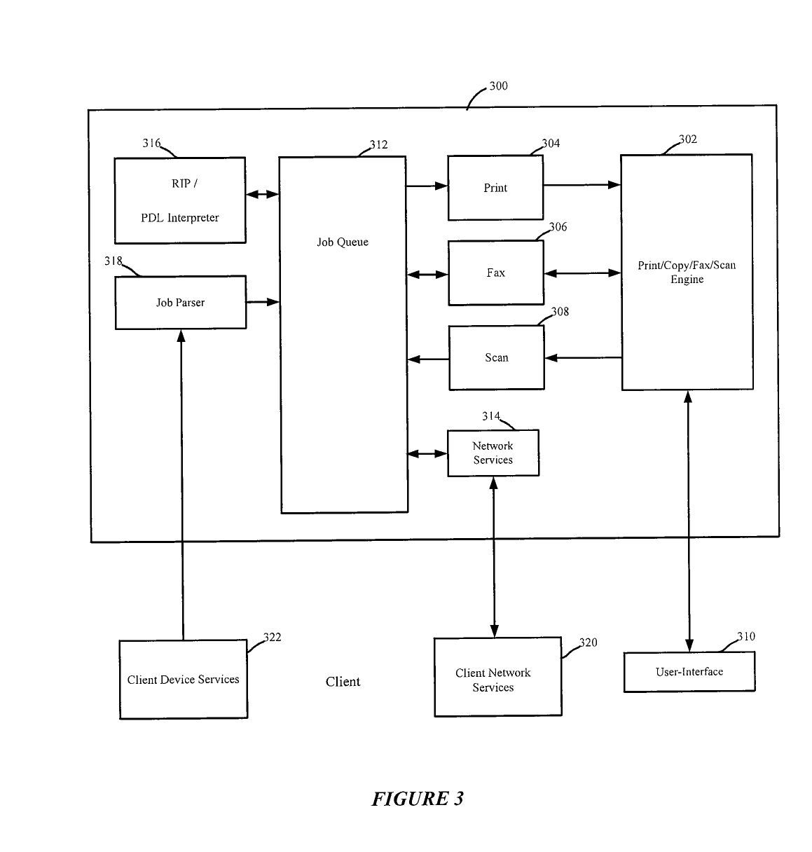

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and are intended as such when used hereinafter. Furthermore, the use of the controller 108 hereinafter is for the example embodiment only, and other embodiments, which will be apparent to one skilled in the art, are capable of employing the system and method for document processing job management of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing images, advertisements, user information, location information, output templates, mapping data, multimedia data files, fonts, and the like.

Illustrated in FIG. 1 is a kiosk 114, communicatively coupled to the document processing device 104, and in effect, the computer network 102. It will be appreciated by those skilled in the art that the kiosk 114 is capable of being implemented as separate component of the document processing device 104, or as integral components thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes a display 116 and user input device 118. As will be understood by those skilled in the art the kiosk 114 is capable of implementing a combination user input device/display, such as a touch screen interface. According to one embodiment of the subject application, the kiosk 114 is suitably adapted to display prompts to an associated user, receive instructions from the associated user, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

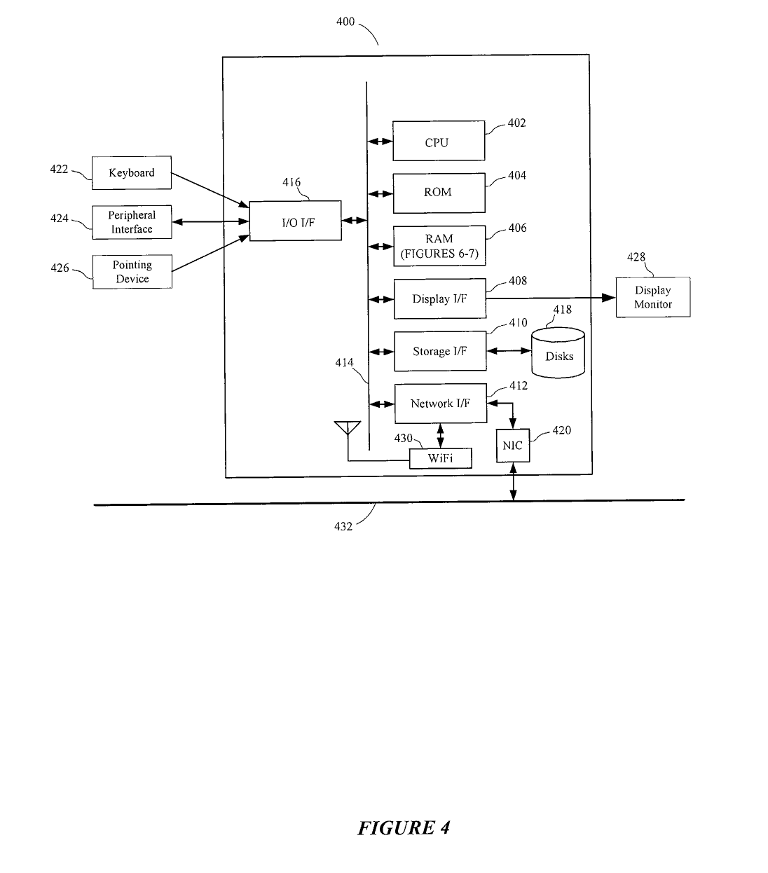

The system 100 illustrated in FIG. 1 further depicts a workstation 122, in data communication with the computer network 102 via a communications link 124. It will be appreciated by those skilled in the art that the workstation 122 is shown in FIG. 1 as a computer workstation for illustration purposes only. As will be understood by those skilled in the art, the workstation 122 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 122 is suitably adapted to receive and modify image data, perform color calculations and conversions, generate display data, generate output data, or the like, to the document processing device 104, or any other similar device coupled to the computer network 102. The functioning of the workstation 122 will better be understood in conjunction with the block diagrams illustrated in FIG. 4, explained in greater detail below.

The system 100 of FIG. 1 also includes a server 126 suitably adapted to facilitate the database 128 representative of document processing jobs to be processed by one or more document processing devices, e.g. the document processing device 104. Preferably, the server 126 is communicatively coupled to the computer network 102 via a suitable communications link 130. It will be appreciated by those skilled in the art that the server 126 comprises hardware, software, and combinations thereof suitably adapted to provide one or more services, web-based applications, storage options, and the like, to networked devices. In accordance with one embodiment of the subject application, the server 126 includes various components, implemented as hardware, software, or a combination thereof, for managing the retention of electronic data, performing searches, storing advertisements, storing account information, storing billing information, retrieval of documents, and the like, which are accessed via the computer network 102.

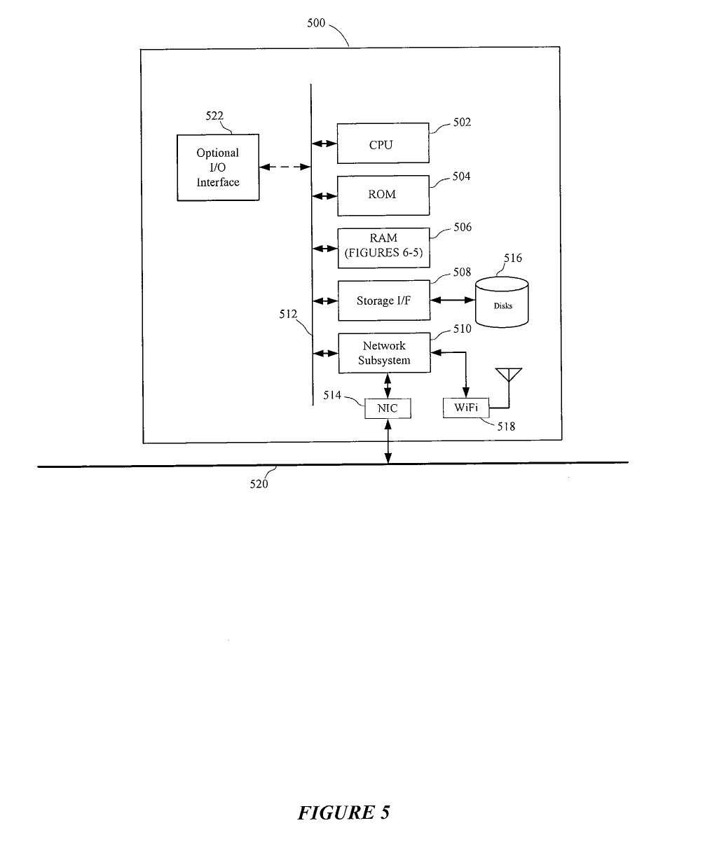

The communications link 130 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components described with respect to the server 126 hereinafter are capable of implementation on any computing device coupled to the computer network 102 and functioning as a backend server. The functioning of the server 126 will better be understood in conjunction with the block diagrams illustrated in FIG. 5, explained in greater detail below.

Communicatively coupled to the server 126 is the data storage device 128. In accordance with the preferred embodiment of the subject application, the data storage device 128 is any mass storage device, or plurality of such devices, known in the art including, for example and without limitation, magnetic storage drives, a hard disk drive, optical storage devices, flash memory devices, or any suitable combination thereof. In the preferred embodiment, the data storage device 128 is suitably adapted to store document processing jobs, job data, location data, software updates, update lists, electronic database data, document data, image data, account data, user data, and the like. It will be appreciated by those skilled in the art that while illustrated in FIG. 1 as being a separate component of the system 100, the data storage device 128 is capable of being implemented as internal storage component of the server 126, or the like, such as, for example and without limitation, an internal hard disk drive, or the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 200 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by the bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a hardware diagram of a suitable workstation 400, shown in FIG. 1 as the workstation 122, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

Turning now to FIG. 5, illustrated is a representative architecture of a suitable server 500, shown in FIG. 1 as the server 126, on which operations of the subject system are completed. Included is a processor 502, suitably comprised of a central processor unit. However, it will be appreciated that processor 502 may advantageously be composed of multiple processors working in concert with one another as will be appreciated by one of ordinary skill in the art. Also included is a non-volatile or read only memory 504 which is advantageously used for static or fixed data or instructions, such as BIOS functions, system functions, system configuration, and other routines or data used for operation of the server 500.

Also included in the server 500 is random access memory 506, suitably formed of dynamic random access memory, static random access memory, or any other suitable, addressable memory system. Random access memory provides a storage area for data instructions associated with applications and data handling accomplished by the processor 502.

A storage interface 508 suitably provides a mechanism for volatile, bulk or long term storage of data associated with the server 500. The storage interface 508 suitably uses bulk storage, such as any suitable addressable or serial storage, such as a disk, optical, tape drive and the like as shown as 516, as well as any suitable storage medium as will be appreciated by one of ordinary skill in the art.

A network interface subsystem 510 suitably routes input and output from an associated network allowing the server 500 to communicate to other devices. The network interface subsystem 510 suitably interfaces with one or more connections with external devices to the server 500. By way of example, illustrated is at least one network interface card 514 for data communication with fixed or wired networks, such as Ethernet, token ring, and the like, and a wireless interface 518, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 520, suitably comprised of a local area network, wide area network, or a combination thereof.

Data communication between the processor 502, read only memory 504, random access memory 506, storage interface 508 and the network subsystem 510 is suitably accomplished via a bus data transfer mechanism, such as illustrated by bus 512.

Suitable executable instructions on the server 500 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 522 as will be appreciated by one of ordinary skill in the art.

In operation, login data is first received corresponding to the identity of an associated user. A plurality of electronic documents are then associatively stored with at least one user identifier in an associated data storage. A default menu is then generated on a user interface associated with a document processing device and an actively displayed default menu on the user interface is determined. Document set data is then generated corresponding to an association of electronic documents in the data storage and received login data based upon a correlation between the login data and the associated user identifier. Summary listing data is then generated that identifies each electronic document in the data storage based upon the generated document set data and upon the determination that a default menu is actively displayed on the user interface. Thereafter, a display is generated corresponding to the summary listing.

In accordance with one example embodiment of the subject application, electronic documents are first stored in the data storage device 110, the data storage device 128, or other suitable storage in association with at least one user identifier. Preferably, the user identifier corresponds to a user associated with the generation or transmittal of the electronic document. Preselected document processing data is then stored in association with each electronic document in the associated data storage 110, 128, or the like. According to one embodiment of the subject application, a user selects an electronic document on which a desired document processing operation is to be performed by the document processing device 104. The user submits the job, i.e. the electronic document and processing data, to the document processing device 104 via the workstation 122, via transmittal to the document processing device 104 over the computer network 102, or the like. The skilled artisan will appreciate that the user is capable of communicating the electronic document and processing data to a backend component, such as the server 126, which facilitates the transmittal to the document processing device 104.

The user then logs onto the document processing device 104 via the user interface 106 or kiosk 114 such that the controller 108 or other suitable component associated with the document processing device 104 receives login data corresponding to the identity of the associated user. Preferably, the user inputs a username, password, account number, or the like, via which the document processing device 104 identifies the user. A default menu is then generated on the user interface 106 or touch screen display 116 associated with the document processing device 104. It will be appreciated by those skilled in the art that the default menu includes, for example and without limitation, customized icons associated with document processing operations, user information, standard (default) document processing options/operations, or the like. As the skilled artisan will appreciate, a myriad of menus are capable of being displayed on the user interface 106 or display 116 corresponding to document processing operations such that the controller 108 or other suitable component associated with the document processing device 104 then determines the actively displayed menu on the user interface 106 or display 116.

The controller 108 or other suitable component associated with the document processing device 104 then generates document set data corresponding to a set of previously submitted electronic documents associated with the user based upon the received login data. The skilled artisan will appreciate that the received login data is suitably associated with the user identifier stored in association with the electronic documents on the data storage device 110, the data storage device 128, or the like. A determination is then made whether the determined actively displayed menu corresponds to the default menu. In the event that the actively displayed menu is not the default menu, the controller 108 directs the user interface 106 or display 116 to suspend the display of any document set data until such time as the default menu is actively displayed.

When the controller 108 or other suitable component associated with the document processing device 104 determines that the actively displayed menu is the default menu, summary listing data is generated identifying each electronic document stored on the data storage device 110 or 128 corresponding to the document set data. That is, a summary list is generated corresponding to those electronic documents and associated processing operations associated with the received user login data. A display is then generated on the user interface 106 or touch screen display 116 corresponding to the summary listing data.

Upon receipt of selection data corresponding to a selection by the user of one of the electronic documents displayed in the summary listing, the document processing device 104 performs the preselected document processing operation associated with the electronic document. When additional electronic documents remain in the summary listing, and the default menu is still actively displayed, the summary listing data is updated to reflect the performance of the document processing operation on the selected electronic document. A suitable prompt is then generated on the user interface 106, the touch screen display 116, or the like, indicating to the associated user to select a second, or other document associated with the summary listing data. A release instruction is then received from the associated user corresponding to another electronic document in the summary listing. The controller 108 or other suitable component associated with the document processing device 104 then facilitates the performance of the preselected document processing operation sequentially on a subsequently selected document based upon the received release instruction.

When another document remains in the summary listing data that still requires processing, a determination is made by the controller 108 or other suitable component associated with the document processing device 104 whether the actively displayed menu is the default menu. In the event that the actively displayed menu is not the default menu, the display of the summary listing data is suspended on the user interface 106 or touch screen display 116 until such time as the default menu is actively displayed. When it is determined that the actively displayed menu is the default menu, operations continue as set forth above with respect to the first electronic document. Once all documents represented in the summary listing data have been released, the operations of the subject application terminate.

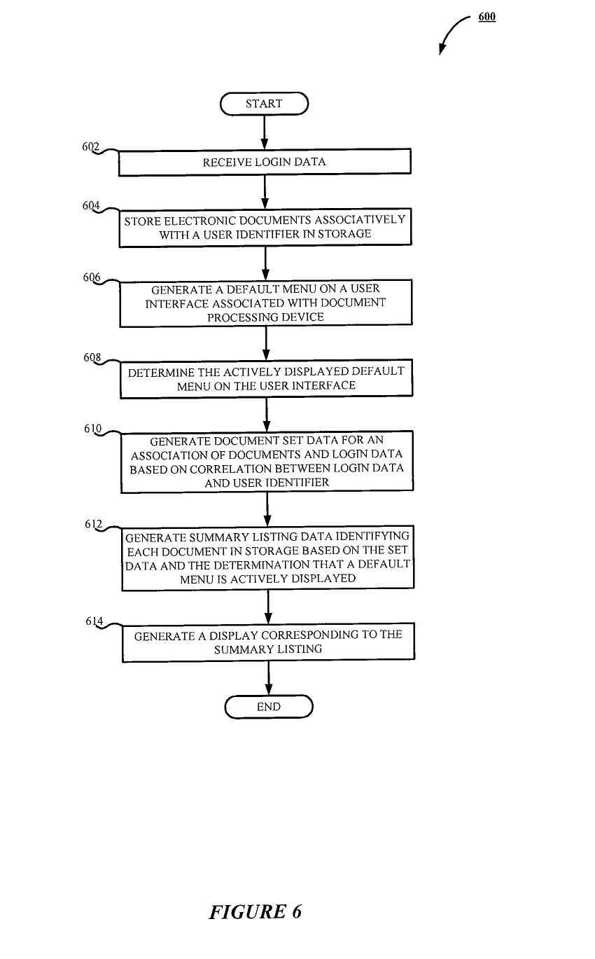

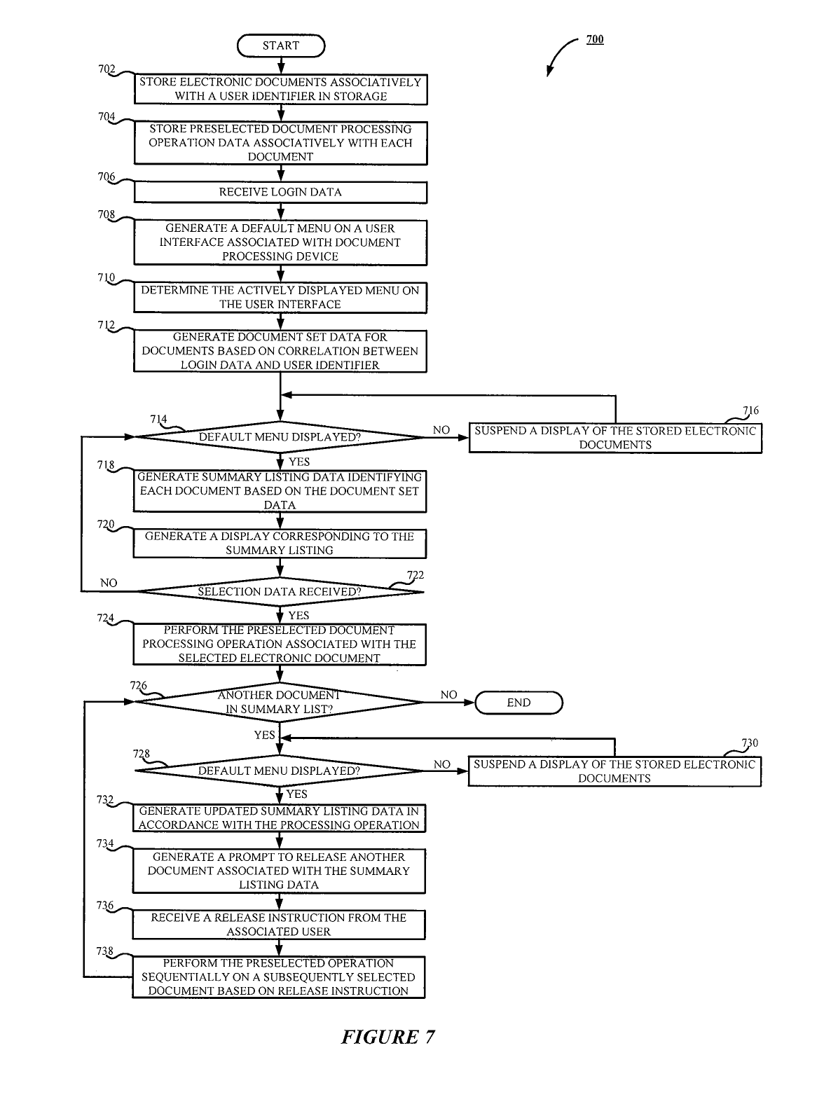

The skilled artisan will appreciate that the subject system 100 and components described above with respect to FIG. 1, FIG. 2, FIG. 3, and FIG. 4 will be better understood in conjunction with the methodologies described hereinafter with respect to FIG. 6 and FIG. 7. Turning now to FIG. 6, there is shown a flowchart 600 illustrating a method for document job management in accordance with one embodiment of the subject application. For example purposes only, reference is made hereinafter to the controller 108 or other suitable component associated with the document processing device 104 performing the methodology of FIG. 6. The skilled artisan will appreciate that the kiosk 114, the workstation 122 or other suitable computing device are equally capable of implementing the method for document job management as set forth in the subject application. Beginning at step 602, login data is received by the controller 108 or other suitable component associated with the document processing device corresponding to the identity of an associated user. It will be appreciated by those skilled in the art that the login data is capable of being received via the user interface 106, the touch screen display 116, the user input device 118, or the like. Preferably, the login data includes, for example and without limitation, a username, a password, biometric data, or other suitable identifying data.

At step 604, electronic documents are stored in the data storage device 110, the database 128, or the like in association with at least one user identifier. In accordance with one example embodiment of the subject application, the server 128 or controller 108 receives multiple electronic documents from an associated user for processing by the document processing device 104 and stores these documents in association with a user identifier on the data storage device 110, the data storage device 128, or the like. It will be appreciated by those skilled in the art that such electronic documents are capable of originating from a portable storage medium, from the workstation 122, or the like. The controller 108 or other suitable component associated with the document processing device 104 then generates a default menu on the user interface 106 associated with the document processing device 104 at step 606. In accordance with one embodiment of the subject application, the default menu is generated on the touch screen display 116 of the kiosk 114 associated with the document processing device 104. The skilled artisan will appreciate that such an embodiment is equally capable of implementation in accordance with the methodology set forth in FIG. 6.

At step 608, the controller 108 or other suitable component associated with the document processing device 104 determines the actively displayed default menu on the user interface 106. The controller 108 or other suitable component associated with the document processing device 104 then generates document set data at step 610 for an association of documents and login data based upon the correlation between the received login data and user identifiers associated with the documents. Stated another way, the controller 108 or other suitable component associated with the document processing device 104 generates document set data of all electronic documents associated with a given user based upon the login data received from the user and the user identifiers associated with the documents. Summary listing data is then generated at step 612 identifying each electronic document in the data storage 110 or 128 based upon the document set data and the determination that a default menu is actively displayed on the user interface 106. At step 614 a display is generated on the user interface 106 associated with the document processing device 104 corresponding to the generated summary listing. It will be appreciated by those skilled in the art that the display of the generated summary listing is also capable of occurring on the touch screen display 116 of the kiosk 114 associated with the document processing device 104.

Referring now to FIG. 7, there is shown a flowchart 700 illustrating a method for document job management in accordance with one embodiment of the subject application. For example purposes only, reference is made hereinafter to the computer workstation 122 implementing the methodology set forth in FIG. 6. The skilled artisan will appreciate that the kiosk 114, the controller 108 or other suitable component associated with the document processing device 104, or any other suitable computing device are equally capable of implementing the subject application. The method of FIG. 7 begins at step 702, whereupon one or more electronic documents are stored in association with at least one user identifier on a suitable data storage, e.g. the data storage device 110 associated with the document processing device 104, the data storage device 128 associated with the server 126, or the like. According to one embodiment of the subject application, the user identifier corresponds to a user associated with the generation or transmittal of the electronic document to which it is associated.

At step 704, preselected document processing data is stored in association with each electronic document in the associated data storage 110, 128, or the like. In accordance with one embodiment of the subject application, the associated user submits a desired document processing operation for performance by the document processing device 104 for each of the electronic documents received at step 702. According to one example embodiment of the subject application, the associated user submits the electronic document and processing data to the document processing device 104 via the workstation 122, via transmittal to the document processing device 104 over the computer network 102, or the like. It will be appreciated by those skilled in the art that the user is capable of communicating the electronic document and processing data first to the server 126, which thereafter facilitates the transmittal to the document processing device 104.

Login data is then received at step 706 by the controller 108 or other suitable component associated with the document processing device 104 corresponding to the identity of the user. In accordance with one example embodiment of the subject application, the user inputs login data via the user interface 106 or kiosk 114 such that the controller 108 or other suitable component associated with the document processing device 104. In accordance with one embodiment of the subject application, the user inputs a username, password, account number, or the like, via which the document processing device 104 identifies the user. At step 708, a default menu is generated on the user interface 106 or touch screen display 116 associated with the document processing device 104. Preferably, the default menu suitably represents, for example and without limitation, a graphical user interface displaying customized icons associated with document processing operations, user information, standard (default) document processing options/operations, or the like. The controller 108 or other suitable component associated with the document processing device 104 then determines the actively displayed menu on the user interface 106 or display 116 at step 710. As the skilled artisan will appreciate, a myriad of menus are capable of being displayed on the user interface 106 or display 116 corresponding to document processing operations such that the controller 108 or other suitable component associated with the document processing device 104 must first determine which of such menus is actively being displayed on the user interface 106 or touch screen display 116.

At step 712, the controller 108 or other suitable component associated with the document processing device 104 generates document set data corresponding to a set of previously submitted electronic documents associated with the user based upon the received login data. It will be appreciated by those skilled in the art that the received login data is suitably associated with the user identifier stored in association with the electronic documents on the data storage device 110, the data storage device 128, or the like. A determination is then made at step 714 whether the actively displayed menu determined at step 710 corresponds to the default menu. Upon a determination at step 714 that the actively displayed menu is not the default menu, flow proceeds to step 716. At step 716, the controller 108 directs the user interface 106 or display 116 to suspend the display of any document set data until such time as the default menu is actively displayed.

Upon a determination at step 714 that the actively displayed menu is the default menu, flow proceeds to step 718, whereupon the controller 108 or other suitable component associated with the document processing device 104 generates summary listing data identifying each electronic document stored on the data storage device 110 or 128 corresponding to the document set data. Stated another way, a summary list is generated by the controller 108 or other suitable component associated with the document processing device 104 of those electronic documents and corresponding document processing operations associated with the received user login data.

At step 720, a display is generated on the user interface 106 or touch screen display 116 corresponding to the summary listing data. A determination is then made at step 722 whether selection data has been received from the associated user corresponding to a selection of at least one of the electronic documents displayed in the summary listing data. When selection data has not yet been received, e.g. after a predetermined period of time, operations return to step 714, whereupon the actively displayed menu is then determined.

Once selection data corresponding to a selection by the user of one of the electronic documents displayed in the summary listing has been received, flow proceeds to step 724. At step 724, the document processing device 104 performs the preselected document processing operation associated with the selected electronic document. A determination is then made at step 726 whether any additional electronic documents remain in the summary listing data. Upon a determination at step 726 that no further electronic documents remain in the summary listing, operations with respect to the methodology of FIG. 7 terminate.

Upon a determination at step 726 that one or more additional electronic documents remain in the summary listing, flow proceeds to step 728, whereupon a determination is made whether the default menu is being actively displayed on the user interface 106 or touch screen display 116. When it is determined at step 728 that the actively displayed menu is not the default menu, flow proceeds to step 730, whereupon the display of the stored electronic documents, e.g. the summary listing data, is suspended with respect to the user interface 106 or touch screen display 116. When it is determined at step 728 that the default menu is still being actively displayed, the summary listing data is updated at step 732 in accordance with the performance of the preselected document processing operation on the selected electronic document.

At step 734, a prompt is generated on the user interface 106, the touch screen display 116, or the like, indicating to the associated user to select another document associated with the summary listing data. At step 736, a release instruction is received from the associated user corresponding to another electronic document in the summary listing. It will be appreciated by those skilled in the art that the release instruction is capable of being received via user interaction at the user interface 106, the touch screen display 116, or the like. Flow then proceeds to step 738, whereupon the controller 108 or other suitable component associated with the document processing device 104 facilitates the performance of the preselected document processing operation sequentially on the subsequently selected document based upon the received release instruction.

Operations then return to step 726, whereupon a determination is made whether one or more electronic documents remain in the summary listing data. When another document remains in the summary listing data that still requires processing, flow proceeds to step 728, whereupon a determination is made by the controller 108 or other suitable component associated with the document processing device 104 whether the actively displayed menu is the default menu. Upon a determination at step 728 that the actively displayed menu is not the default menu, the display of the summary listing data is suspended on the user interface 106 or touch screen display 116 until such time as the default menu is actively displayed. Following a determination at step 728 that the actively displayed menu is the default menu, flow proceeds to step 732 and operations continue with respect to steps 732-738, as set forth above. Following the determination at step 726 that no additional electronic documents remain in the summary listing data, operations with respect to FIG. 7 terminate.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing job management system comprising:
login means adapted for receiving login data corresponding to an identity of an associated user;
a data storage, the data storage adapted for storing a plurality of electronic documents associatively with at least one user identifier;
means adapted for generating a default menu on a user interface associated with a document processing device;
sensing means adapted for determining an actively displayed default menu on the user interface;
determining means adapted for generating document set data corresponding to an association of electronic documents in the data storage and received login data in accordance with a correlation between received login data and the at least one user identifier;
means adapted for generating summary listing data identifying each electronic document in the data storage in accordance with generated document set data and an output of the sensing means; and
means adapted for generating a display corresponding to the summary listing.

2. The system of claim 1 further comprising:
means adapted for receiving selection data corresponding to at least one selected electronic document associated with the summary listing data; and
document processing means adapted for performing at least one document processing operation on the at least one selected electronic document.

3. The system of claim 2 wherein:
data corresponding to at least one preselected document processing operation is associatively stored with each of the plurality of electronic documents; and
the document processing means includes means adapted for performing the at least one preselected document processing operation associated with each selected electronic document.

4. The system of claim 2 further comprising:
means adapted for generating a prompt corresponding to a release of a second electronic document associated with the summary listing data;
means adapted for receiving a release instruction from the associated user; and
wherein the document processing means further includes means for performing the at least one preselected document processing operation sequentially on at least a subsequent selected electronic document in accordance with a received release instruction.

5. The system of claim 2 further comprising means adapted for generating updated summary listing data in accordance with each document processing operation.

6. The system of claim 1 further comprising means adapted for suspending a display of the summary listing in accordance with an output of the sensing means indicative that the default display is inactive.

7. A document processing job management method comprising the steps of:
receiving login data corresponding to an identity of an associated user;
storing a plurality of electronic documents associatively with at least one user identifier in an associated data storage;
generating a default menu on a user interface associated with a document processing device;
determining an actively displayed default menu on the user interface;
generating document set data corresponding to an association of electronic documents in the data storage and received login data in accordance with a correlation between received login data and the at least one user identifier;
generating summary listing data identifying each electronic document in the data storage in accordance with generated document set data and the determination that a default menu is actively displayed on the user interface; and
generating a display corresponding to the summary listing.

8. The method of claim 7 further comprising the steps of:
receiving selection data corresponding to at least one selected electronic document associated with the summary listing data; and
performing at least one document processing operation on the at least one selected electronic document.

9. The method of claim 8 wherein:
data corresponding to at least one preselected document processing operation is associatively stored with each of the plurality of electronic documents; and
the at least one preselected document processing operation associated with each selected electronic document is performed.

10. The method of claim 8 further comprising the steps of:
generating a prompt corresponding to a release of a second electronic document associated with the summary listing data;
receiving a release instruction from the associated user; and
performing the at least one preselected document processing operation sequentially on at least a subsequent selected electronic document in accordance with a received release instruction.

11. The method of claim 8 further comprising the step of generating updated summary listing data in accordance with each document processing operation.

12. The method of claim 7 further comprising the step of suspending a display of the summary listing in accordance with an indication that the default display is inactive.
